(19) United States
(12) Patent Application Publication
(10) Pub. No.: US 2017/0368746 A1
(43) Pub. Date: Dec. 28, 2017

(54) PHANTOM PRODUCTION APPARATUS USING 3D PRINTER, AND PRODUCTION METHOD USING SAME

(71) Applicants: KOREA PHOTONICS TECHNOLOGY INSTITUTE, Gwangju (KR); PUKYONG NATIONAL UNIVERSITY INDUSTRY-UNIVERSITY COOPERATION FOUNDATION, Busan (KR)

(72) Inventors: Byeong-il LEE, Gwangju (KR); Hyun Wook KANG, Busan (KR); Hanna KIM, Busan (KR)

(73) Assignees: KOREA PHOTONICS TECHNOLOGY INSTITUTE, Gwangju (KR); PUKYONG NATIONAL UNIVERSITY INDUSTRY-UNIVERSITY COOPERATION FOUNDATION, Busan (KR)

(21) Appl. No.: 15/529,735

(22) PCT Filed: Apr. 5, 2016
(86) PCT No.: PCT/KR2016/003510

§ 371 Date: May 25, 2017

(30) Foreign Application Priority Data
Apr. 10, 2015 (KR) 10-2015-0051113

(51) Int. Cl. B29C 64/209; B33Y 30/00; B33Y 10/00; B33Y 50/02; B29C 64/118; B29C 64/393; B29L 31/00; B29L 9/00

(52) U.S. Cl. CPC B29C 64/209; B29C 64/118; B33Y 30/00; B29C 64/393; B33Y 10/00; B33Y 50/02; B29L 2009/00; B29L 2031/753

(57) ABSTRACT

Disclosed is a device for manufacturing a skin-simulating phantom, which has properties that are similar to those of real skin, using a 3D printer so that layers are stacked to form a multi-layered structure and a nozzle tip connected to the 3D printer is used to provide roughness, and a method of manufacturing a skin-simulating phantom using the same. According to this present invention, solutions can be mixed, depending on the component constitution reflecting the optical properties of the skin, using a program that is set depending on the type of skin. The output condition of the 3D printer can be controlled using a program that is set so as to conduct a step of comparing measured thickness and roughness values to those of the real skin and performing feedback. The nozzle tip connected to the 3D printer can move up and down to provide roughness. Further, the multi-layered structure can be manufactured using the 3D printer, thereby outputting and embodying lesions.

### TECHNICAL FIELD

The present invention relates to a device and a method for manufacturing a phantom, which has optical and structural properties that are similar to those of real skin, using a 3D printer. Particularly, the present invention relates to a device and a method for manufacturing a phantom which simulates various types of skin and skin lesions.

### BACKGROUND ART

‘Leukoplakia’, a kind of skin pigment lesion diseases, is a common disease found in about 0.5 to 2.0% of the population. Leukoplakia occurs indiscriminately in all races and regions, and most frequently between the ages of 10 and 30. ‘Telangiectasis’, another skin vascular lesion disease, occurs at a men/women gender ratio of 1:2 to 1:4, meaning that it is more common in women. Telangiectasis may be easily found in those older than 70.

Recently, laser treatment targeting a lesion portion has been frequently used to treat such skin lesion diseases. Such targeted laser treatment has been known to have a variety of effects, and to also have an outstanding skin regeneration effect after treatment. A survey shows that the global market for laser medical devices for the purpose of skin disease diagnosis and treatment was on the scale of $3.0 billion in 2011, and since then, has recorded an average annual growth rate of 17.3%, and is expected to reach about $6.8 billion in 2016.

The current annual population receiving treatment for skin diseases was 52,785 in 2013, and is on a trend that shows an average annual increase of 3.29% since 2008. In Korea, animal models have been used in the treatment and diagnosis of skin pigment lesions or vascular lesions using a laser, and normal human-skin simulating phantoms have been manufactured. However, phantoms that have various skin colors and skin layers having different thicknesses have not yet been manufactured.

A phantom, simulating human skin, may be used as a skin model, which has mechanical/optical properties that are similar to those of real skin tissue, for the purpose of treating and eliminating skin pigment lesions (leukoplakia, tattoos, etc.) and vascular lesions (facial flushing, telangiectasis, etc.) in the medical community.

Examples of the related prior art include Korean Patent Application Publication No. 10-2013-0136419 (Dec. 12, 2013) and United States Patent No. 2010-0196867 (Aug. 5, 2010). Phantoms manufactured using a known molding and spraying process have drawbacks in that the manufacturing process is rather complicated and difficult and it is impossible to form multiple layers using stacking. Further, pigment lesions may not be simulated on the corium or epidermis, as it is impossible to form multiple layers using stacking.

3D printing technology may be used to control the layer thickness, thereby easily simulating a skin epidermis layer having a micro-unit size. When the 3D printing technology is applied, it is possible to repeatedly manufacture the phantom and to form the multiple layers using stacking, and accordingly, it is expected that stable experimental results will be obtained.

### DISCLOSURE

### Technical Problem

Accordingly, the present invention has been made keeping in mind the above problems occurring in the related art, and an object of the present invention is to provide a device and a method for manufacturing a phantom having a multi-layered structure using a 3D printer in order to ensure an optical property and a thickness that are similar to those of real skin.

Another object of the present invention is to provide a device and a method for manufacturing a phantom to embody the roughness of the epidermis of the phantom, thereby simulating various types of skin.

Yet another object of the present invention is to provide a device and a method for manufacturing a phantom to embody lesions formed in an epidermis or a corium while phantom layers are stacked.

### Technical Solution

In order to accomplish the above objects, the present invention provides a device for manufacturing a phantom that simulates skin using a 3D printer. The device includes a pump unit storing colored solutions which are mixed depending on the properties of the skin layer to be simulated, a control unit controlling the 3D printer and the pump unit so that the colored solutions are sprayed to form at least one phantom layer, and a nozzle tip connected to the 3D printer to extrude the colored solutions. The nozzle tip may be controlled by the control unit to embody a rough epidermis of the formed phantom layer.

In order to accomplish the above objects, the present invention also provides a system for manufacturing a phantom simulating a skin using a 3D printer. The system includes a pump unit storing colored solutions which are mixed depending on the properties of the skin layer to be simulated, a control unit controlling the 3D printer and the pump unit so that the colored solutions are sprayed to form at least one phantom layer, a nozzle tip connected to the 3D printer to extrude the colored solutions, and an inspection device measuring any one of the optical properties, roughness, and thickness of the phantom layer, which is formed by curing the colored solutions sprayed from the nozzle tip.

In order to accomplish the above objects, the present invention also provides a method of manufacturing a phantom simulating a skin using a 3D printer. The method includes a mixing step of manufacturing one or more types of colored solutions having the properties of the skin layer to be simulated, a first output step of extruding a first colored solution, which is manufactured during the mixing step, to manufacture a corium phantom layer, and a second output step of controlling the nozzle tip of the 3D printer while a second colored solution, which is manufactured during the mixing step, is extruded to thus manufacture a rough epidermis phantom layer.

### Advantageous Effects

According to the present invention, since a nozzle tip is connected to a 3D printer, a multi-layered structure including subcutaneous fat, a corium, and an epidermis may be simulated using a stacking process.

Further, according to the present invention, a device for manufacturing a phantom may be connected to an inspection device that measures the optical properties, roughness, and thickness of the simulated phantom in order to manufacture a skin phantom that is similar to real skin.

Further, according to the present invention, a nozzle tip having polygonal extrusion holes therein may be controlled to be vibrated up and down while horizontally moving to thus embody the roughness of the epidermis of the manufactured phantom, thereby simulating various types of skin.

Further, according to the present invention, a pigment solution may be applied on the surface of a corium layer during a first output step, or the pigment solution may be applied on the surface of an epidermis phantom layer during a second output step, thereby simulating a vascular lesion and a pigment lesion, which are similar to those of the real skin, in the corium layer and in the epidermis layer, respectively.

### DESCRIPTION OF DRAWINGS

FIG. 1 is a mimetic view schematically showing a device for manufacturing a phantom according to an embodiment of the present invention;

FIG. 2 is of mimetic views showing driving and the type of extrusion holes in a nozzle tip, which are set according to the embodiment of the present invention;

FIG. 3 is a mimetic view showing the constitution of a system for manufacturing a phantom according to the embodiment of the present invention;

FIG. 4 shows a spectrophotometer which is used to measure the optical properties of an epidermis phantom layer according to the embodiment of the present invention;

FIGS. 5a and 5b are comparative pictures showing that the thickness of the epidermis phantom layer, which is manufactured using a spin coating process, and the thickness of the epidermis phantom layer according to the embodiment of the present invention are measured and compared; and

FIG. 6 is a flowchart showing a method of manufacturing a phantom according to the embodiment of the present invention.

### BEST MODE

The present invention may be modified in various forms and may have a variety of embodiments, and specific embodiments are illustrated in the appended drawings and are described in detail in the specification. However, the following description does not limit the present invention to the specific embodiments, and should be understood to include all variations, equivalents or substitutions within the spirit and scope of the present invention. Furthermore, descriptions of known techniques, even if they are pertinent to the present invention, are considered unnecessary and may be omitted insofar as they would make the characteristics of the invention unclear.

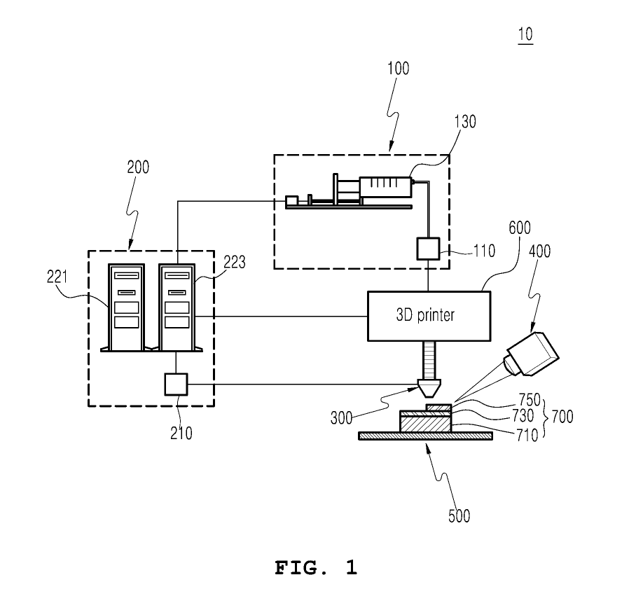

FIG. 1 is a mimetic view schematically showing a device 10 for manufacturing a phantom according to an embodiment of the present invention. Referring to FIG. 1, the device 10 for manufacturing the phantom according to the embodiment of the present invention may include a pump unit 100, a control unit 200, a nozzle tip 300, a light source 400, a print stage 500, and a 3D printer 600.

The device 10 for manufacturing the phantom may embody a multi-layered structure using 3D printing technology, and may also simulate the mechanical/optical properties and lesions of layers. In a known method of manufacturing a phantom using a mold, the volume of a solution is changed due to vaporization that occurs when the solution is cured. Therefore, the method of manufacturing the phantom using the mold faces a limit in capability of manufacturing a phantom having a thin layer. Further, in the method of manufacturing the phantom using the mold, it is very difficult to precisely ensure the thickness thereof, and onerously, the mold must be newly manufactured whenever the phantom is manufactured. Further, in the method of manufacturing the phantom using the mold, it is difficult to embody a skin layer having a multi-layered structure (an epidermis of 50 μm to 0.02 mm, a corium of 1.0 to 4.0 mm, and a subcutaneous fat layer of 3.3 to 7.0 mm).

The number of human-skin simulating phantoms capable of being manufactured using 3D printing technology is 300 or more, and the phantoms may be manufactured so as to have properties, which include the number of skin layers, the skin color, surface roughness, the thickness of each portion, and skin lesions, and which are similar to those of the human body.

The pump unit 100 may include a storage pump 130 and a temperature control motor 110. Colored solutions, mixed depending on the properties of the skin layer to be simulated, may be stored in the storage pump 130. One or more types of colored solutions may be provided depending on the properties of the skin layer to be simulated.

A first colored solution is used to manufacture a corium phantom layer 730, and simulates an optical-scattering property of the human skin. In order to simulate the optical-scattering property, it is preferable that any one selected from 20% Intralipid and cream be mixed with a medium solution. Distilled water and a plastic fluid may be mixed to constitute the medium solution. The plastic fluid may be constituted to include polyvinyl alcohol (PVA), gelatin, agar, or pearl agar.

A second colored solution is used to manufacture an epidermis phantom layer 750, and simulates the optical absorption properties of human skin. Indian ink, hemoglobin, or a coffee solution may be mixed with the medium solution in the second colored solution so as to simulate the optical absorption properties of the skin.

A third colored solution is used to manufacture a subcutaneous fat phantom layer 710, and an optical-absorbing material or an optical-scattering material may be mixed with the medium solution so as to obtain the same absorption ratio or scattering ratio as the skin layer to be simulated.

The temperature of the storage pump 130 may be controlled by the temperature control motor 110 so that the first, second, and third colored solutions are not solidified. It is preferable that the temperature be controlled at about 19 to 100° C.

The nozzle of the 3D printer 600 may independently move in three directions, namely X, Y, and Z directions. It is preferable that the moving speed of the nozzle be 10 to 3000 mm/min. The nozzle of the 3D printer 600 may be connected to a nozzle tip 300. The 3D printer 600 may extrude the colored solution, which is transported through the pump unit 100, through the nozzle tip 300 to thus output a phantom layer 700.

The shape of the layers including the extruded colored solutions may depend on the tip shape and size of the nozzle tip 300. The shape of the layers, which include the colored solutions extruded from the nozzle tip 300, may be varied to thus simulate the rough surface of the phantom. Driving of the nozzle tip 300 may be controlled to adjust the roughness of the phantom surface.

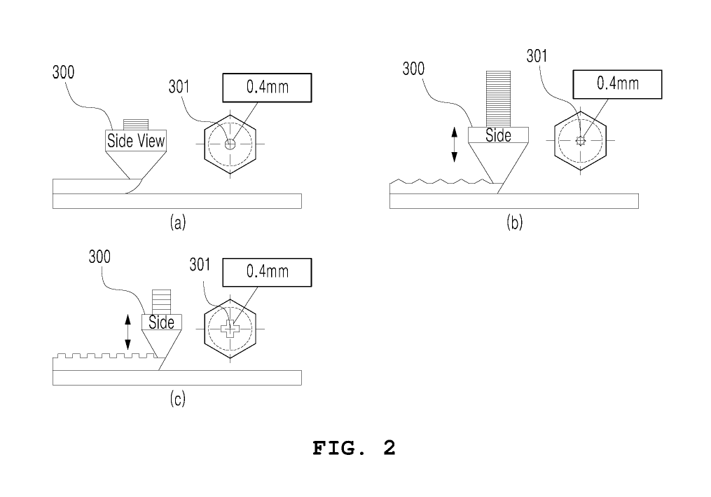

FIG. 2 is of mimetic views showing driving and the type of extrusion holes in the nozzle tip 300, which are set according to the embodiment of the present invention. Referring to FIG. 2, an extrusion hole 301 in the nozzle tip may be 0.2 to 0.4 mm in size. The extrusion hole 301 in the nozzle tip may be polygonal. The nozzle tip 300 may vibrate up and down while horizontally moving so as to stack layers, which include the extruded colored solutions, in any one form of a sine wave, a square wave, and a triangle wave to thus provide the roughness.

FIG. 2a shows that the nozzle tip 300 having the typical circular extrusion hole 301 therein is horizontally controlled. FIG. 2a shows a driving type whereby the nozzle tip 300 is controlled to simulate the subcutaneous fat layer 710, the corium layer 730, and the epidermis layer 750, which do not need to be roughened.

FIG. 2b shows that the nozzle tip 300 having the hexagonal/heptagonal extrusion hole 301 is controlled to be vibrated up and down while horizontally moving. Referring to FIG. 2b, the layers, which include the colored solutions extruded from the nozzle tip 300, may be stacked in any one form of a sine wave and a triangle wave so as to embody the rough epidermis layer 750.

FIG. 2c shows that the nozzle tip 300 having the cross-shaped extrusion hole 301 is controlled so as to vibrate up and down while moving horizontally. Referring to FIG. 2c, the layers including the extruded colored solutions may be stacked in a square wave shape to embody the rough epidermis layer 750.

As in the embodiments of FIGS. 2a, 2b, and 2c, a user may select the shape of the extrusion hole 301 depending on the type of skin to be simulated.

The control unit 200 may control the 3D printer 600 and the pump unit 100 so that the colored solutions are sprayed to form at least one phantom layer 700. The process of manufacturing the phantom may be controlled, and a relatively simple skin phantom having a uniform surface may be embodied based on the setup of the control unit 200. The control unit 200 may include one or more control modules 221 and 223 and an output control motor 210.

The pump unit 100 may be controlled by the first control module 221. The type of skin layer to be simulated may be set by the first control module 221, and the color, the optical properties, and the surface roughness, which are suitable for the skin layer, may be set based on a quantified standard. Raw materials may be mixed using the pump unit 100 based on the setup of the first control module 221.

The 3D printer 600 may be controlled by the second control module 223. Displacement of the nozzle tip 300 in three directions, namely X, Y, and Z directions, and the extrusion speed of the nozzle tip 300 may be determined by the second control module 223. Variables set in the second control module 223 may be transferred to the output control motor 210.

The diameter of the nozzle tip 300 may be controlled, depending on the concentrations of the colored solutions, by the output control motor 210 to thus maintain a constant extrusion speed. The concentrations of the first, second, and third colored solutions depend on the ratio of distilled water in the medium solution, which was manufactured during the mixing step (S100). Since it is difficult to extrude colored solutions having different concentrations at the same speed under the same conditions, the speed needs to be controlled by the output control motor 210. Therefore, it is preferable for the output to be controlled depending on the concentration by the output control motor 210 using a tube having a size of about 1.00 to 2.16 mm.

The colored solution sprayed from the nozzle tip 300 may be cured using the light source 400. The colored solution, which includes a curing agent having a photo-curing property, may be cured using light emitted from the light source 400. Light may be radiated from the light source 400 onto the print stage 500, on which the extruded colored solution is provided. In the present embodiment, a UV lamp may be provided as the light source 400.

The colored solution sprayed from the nozzle tip 300 may be cured to form at least one phantom layer 700 on the print stage 500.

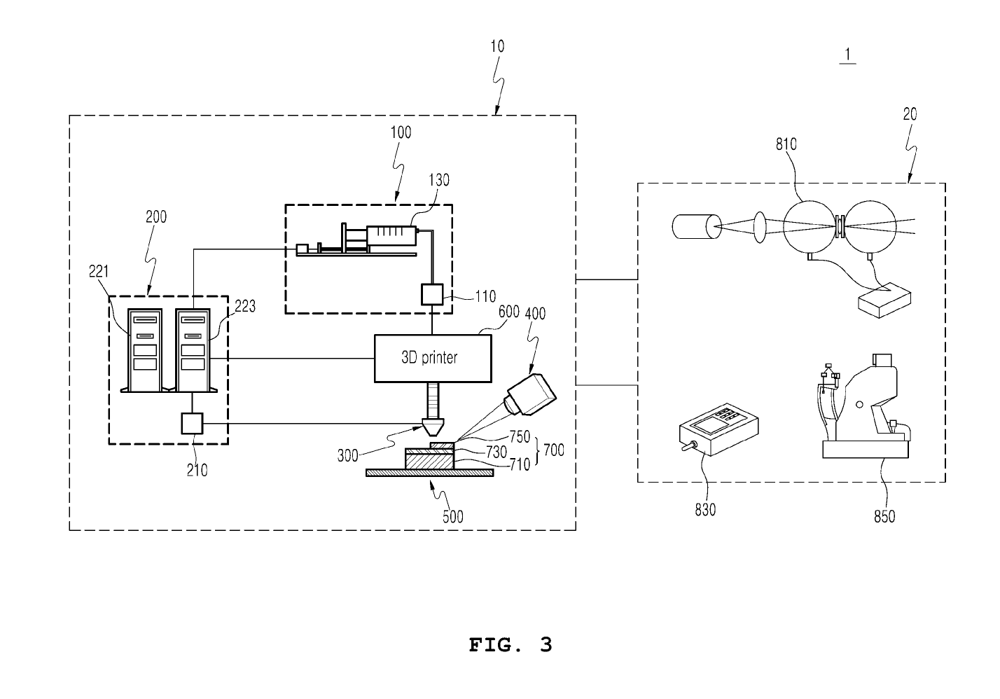

FIG. 3 is a mimetic view showing the constitution of a system 1 for manufacturing a phantom according to the embodiment of the present invention. Referring to FIG. 3, the system 1 for manufacturing the phantom may include the device 10 for manufacturing the phantom, and an inspection device 20 for measuring any one of the optical properties, roughness, and thickness after the phantom layer 700 is manufactured.

The inspection device 20 may include a spectrophotometer 810, a surface roughness meter 830, and an optical coherence tomography (OCT) imager 850.

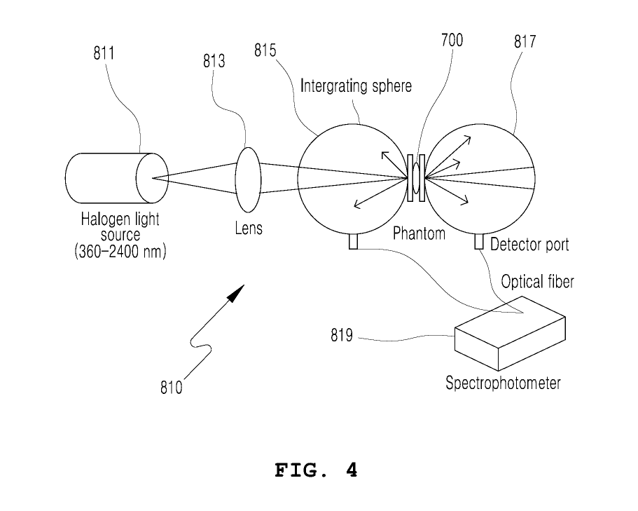

The optical properties of the phantom layer 700 may be measured using the spectrophotometer 810. FIG. 4 shows the spectrophotometer 810 which is used to measure the optical properties of the epidermis phantom layer 750 according to the embodiment of the present invention. Referring to FIG. 4, the spectrophotometer 810 may include integrating spheres 815 and 817, a photo-detector 819, a halogen light source 811, and a lens 813.

Light radiated on the phantom layer 700 may be scattered-reflected with a uniform magnitude by the integrating spheres 815 and 817. The photo-detector 819 may measure the optical properties of the phantom layer 700 using light which is scattered-reflected by the integrating spheres 815 and 817. The halogen light source 811 may emit halogen light to the integrating spheres. The halogen light may be in the range of 360 to 2400 nm. The lens 813 is adjusted so that the light emitted from the halogen light source 811 is refracted and radiated into the integrating spheres 815 and 817.

The spectrophotometer 810 may include the integrating spheres 815 and 817, which scatter-reflect light, which is radiated on the phantom layer 700, with a uniform magnitude, and the photo-detector 819, which measures the optical properties of the phantom layer 700 using the light which is scattered-reflected by the integrating spheres 815 and 817. In more detail, the spectrophotometer may include the photo-detector 819, which receives data from a first integrating sphere 815 and a second integrating sphere 817 and analyzes the data. The first integrating sphere 815 is used to detect the light that is emitted from the halogen light source 811 to the phantom layer 700 while being refracted by the lens 813 and is scattered-reflected at the phantom layer 700, and the second integrating sphere 817 is used to detect light that is scattered after penetrating the phantom layer 700.

The control unit 200 may receive data, which are measured using the spectrophotometer 810, to determine whether the optical properties of the epidermis phantom layer 750 are as desired. It is preferable for the integrating spheres 815 and 817 to use a wavelength of 360 to 2400 mm in order to measure the optical properties of the phantom layer using the spectrophotometer 810.

The depths of cristae cutis and the distance between the cristae cutis may be measured using the surface roughness meter 830 in order to measure the roughness of the epidermis phantom layer 750. The roughness of the human skin may depend on the cristae cutis. The depths of the cristae cutis (DSC) and the distance between the cristae cutis (DCC) affect the roughness of the skin.

Skin having average roughness has a DSC value ranging from 11.79 to 18.08 μm and a DCC value ranging from 301.38 to 555.02 μm, depending on age. The skin of teenagers has a DSC roughness value of 10.66 to 11.32 μm and a DCC roughness value of 300.12 to 339 μm, but the skin of a person in her/his sixties or older has a DSC roughness value of 16.59 to 17.99 μm and a DCC roughness value of 432.22 to 515 μm. Accordingly, it can be seen that roughness increases with increasing age. Accordingly, the control unit 200 may receive data, which are measured using the surface roughness meter 830, to determine whether the roughness of the epidermis phantom layer 750 is as desired.

The OCT 850 may be used to measure the thickness of the epidermis phantom layer 750 using the interference signal of radiated light. The control unit 200 may receive data, which are measured using the OCT 850, to determine whether the thickness of the epidermis phantom layer 750 is as desired. It is preferable that the light that is radiated from the OCT 850 have a wavelength of 1350 nm.

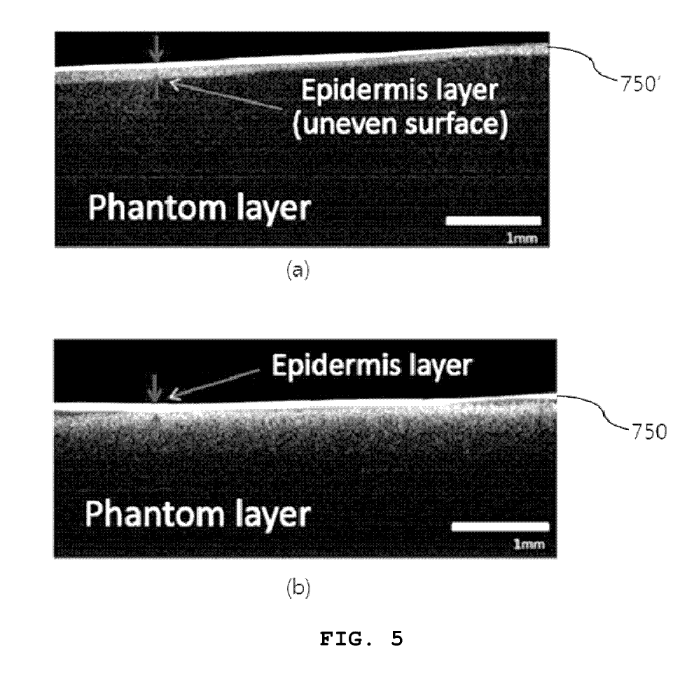

FIGS. 5a and 5b are comparative pictures showing the measured thickness of the epidermis phantom layer 750′, which is manufactured using a spin coating process, and the measured thickness of the epidermis phantom layer 750 according to the embodiment of the present invention. The thickness of the epidermis phantom layers, which are manufactured using the two processes, is measured using the OCT 850.

FIG. 5a shows the thickness of the epidermis phantom layer 750′ manufactured using the known spin coating process. FIG. 5b shows the thickness of the epidermis phantom layer 750 manufactured according to the embodiment of the present invention. From FIGS. 5a and 5b, it can be confirmed that the epidermis phantom layer 750 according to the embodiment of the present invention has a thickness that is more similar to the average epidermal thickness of real human skin, compared to the epidermis phantom layer 750′ manufactured using the spin coating process.

In the present embodiment, the thickness of the epidermis of each portion of the real human body may be 74.9 μm (±12.7) in the forearm, 81.3 μm (±13.5) in the shoulder, 96.5 μm (±16.1) in the hip, and 0.5 mm (±13.5) in the eyelid, and the average epidermal thickness may be set in the range from 50 to 100 μm (±10.5). The control unit 200 may set variables regarding the thickness of each portion of the human body so as to control the 3D printer 600.

The control unit 200 receives the measurement result from the inspection device 20, which measures any one of the optical properties, the roughness, and the thickness of the formed phantom layer, to thus determine whether the measurement result is consistent with the properties of the set skin layer. The control unit 200 may perform feedback, depending on the decision, to control the medium concentration (0.8 to 16 g/100 ml), the output speed (0.1 to 10 ml/hr), the operation speed of the 3D printer (30 to 100 mm/s), the temperature (25 to 90° C.), and the nozzle tip size (0.2 to 1.0 mm).

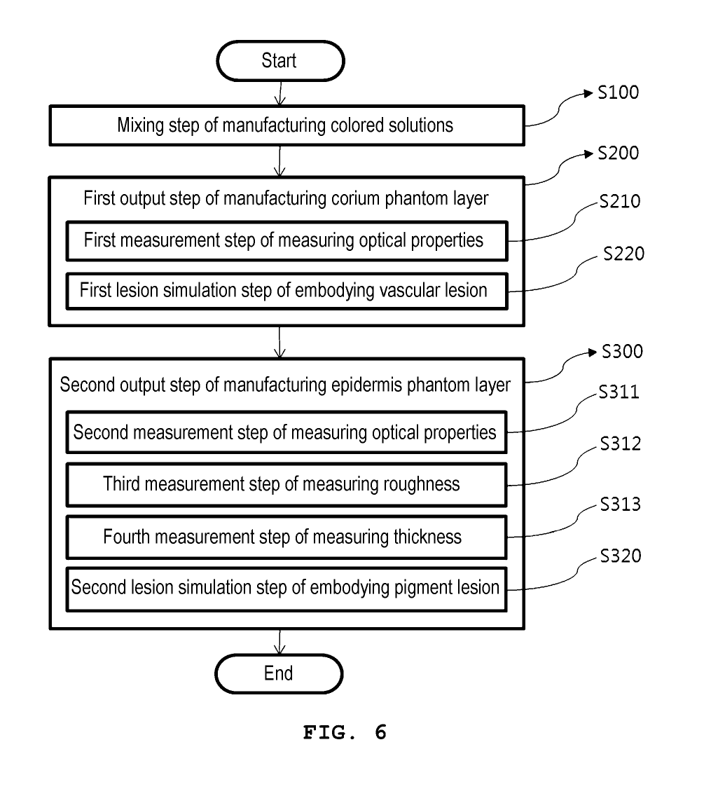

FIG. 6 is a flowchart showing a method of manufacturing a phantom according to the present invention. Referring to FIG. 6, the method of manufacturing the phantom may include a mixing step (S100), a first output step (S200), and a second output step (S300).

The mixing step (S100) includes a step of manufacturing one or more types of colored solutions having the properties of the skin layer to be simulated. A light-scattering material may be added to a medium solution including a plastic fluid to manufacture a first colored solution, which has the light-scattering properties of the skin layer to be simulated, during the mixing step (S100).

Further, a light-absorbing material may be added to the medium solution including the plastic fluid to manufacture a second colored solution, which has the light-absorbing properties of the skin layer to be simulated, during the mixing step (S100).

The colored solutions may be manufactured so as to include 89.95 to 99.90 wt % of the medium solution and 0.01 to 10 wt % of 0.01 to 50.0%-concentrated absorbing/scattering material. In order to exhibit optical properties similar to those of skin tissue, the material having the light-absorbing or scattering properties of each skin layer of human tissue must be mixed with the medium solution at the independently set concentration.

The absorption ratio and the scattering ratio, which are optical properties of real skin, are different for each portion of the human body. The normal epidermis may be set to have an absorption ratio of about 5 to 80 cm⁻¹ and a scattering ratio of about 3 to 130 cm⁻¹ during the mixing step (S100). The normal corium may be set to have an absorption ratio of about 0.5 to 850 cm⁻¹ and the same scattering ratio as the epidermis in order to manufacture the colored solution during the mixing step (S100).

A pigmented dye may be added to the medium solution in order to exhibit the color of the skin during the mixing step (S100). 92.60 to 99.57 wt % of the medium solution and 0.1 to 100 wt % of 0.1 to 10%-concentrated pigmented dye may be mixed to simulate six different types of skin.

The color of the human skin may be classified into six types according to the Fitzpatrick skin type. Type I may be represented by first to fifth grades, which have the smallest amount of melanic pigment in the epidermis, among thirty six grades of ‘von Luschan’, and type VI, which have the largest amount of melanic pigment in the epidermis, may be represented by the twenty ninth to thirty sixth grades.

When the melanic pigment distribution amount is 2.7 to 4.5×10⁻⁷ mmol/dl in the real epidermis (type I), hemoglobin may be included in an amount of about 2.5 to 4.1 mg/dl, and when the melanic pigment distribution amount is 90 to 110×10⁻⁷ mmol/dl (type VI), hemoglobin may be included in an amount of about 2.8 mg/dl.

It is preferable that the colored solution further include a curing agent so as to induce curing by the light source 400. The reason is that light is radiated from the UV lamp after the solution is extruded to thus promote curing of the extruded solution, thereby reducing the manufacturing time of the phantom. It is preferable that the plastic fluid and the curing agent be mixed with each other at a ratio of 2:1 to 6:1 and be mixed with 80 to 100 wt % of distilled water.

The first output step (S200) may include a first measurement step (S210) and a first lesion simulation step (S220). The first output step (S200) includes a step of extruding the manufactured first colored solution so as to manufacture a corium phantom layer.

A third colored solution, which is added so as to impart the properties of a subcutaneous fat layer during the mixing step (S100), may be cured in a mold to manufacture a subcutaneous fat phantom layer 710 during the first output step (S200). The first colored solution may be extruded, after the subcutaneous fat phantom layer 710 is manufactured, on the subcutaneous fat phantom layer 710 to manufacture a corium phantom layer 730 during the first output step (S200).

The first measurement step (S210) includes a step of measuring the optical properties of the manufactured corium phantom layer 730 and returning to the mixing step (S100) when the measured optical properties are inconsistent with the optical properties of the skin to be simulated. When the value measured during the first measurement step (S210) is consistent with the optical properties of the skin, the first lesion simulation step (S220) may be performed.

A pigment solution, which has a color that is different from that of the first colored solution, may be applied on the surface of the corium phantom layer 730 to embody the vascular lesion of the corium layer during the first lesion simulation step (S220). The vascular lesion is formed in the corium layer, which includes many blood vessels distributed therein, in the real skin. For example, the pigment solution may be applied on the manufactured corium phantom layer 730 and then solidified to manufacture the epidermis phantom layer 750 on the corium phantom layer, thereby embodying tattoos.

The second output step (S300) may include a second measurement step (S311), a third measurement step (S312), a fourth measurement step (S313), and a second lesion simulation step (S320). The nozzle tip 300 of the 3D printer 600 may be controlled, while the manufactured second colored solution is extruded, to manufacture the rough epidermis phantom layer 750 during the second output step (S300).

After the epidermis phantom layer 750 is manufactured, the nozzle tip 300 may be vibrated up and down while horizontally moving to embody the rough epidermis phantom layer 750 during the second output step (S300). The driving speed of the nozzle tip 300 may be controlled to stack layers, which include the extruded colored solutions, in any one form of a sine wave, a square wave, and a triangle wave to thus provide various types of roughness during the second output step (S300).

The second measurement step (S311) includes a step of measuring the optical properties of the manufactured epidermis phantom layer 750 and returning to the mixing step (S100) when the measured optical properties are inconsistent with the optical properties of the skin to be simulated. When the value measured during the second measurement step (S311) is consistent with the optical property of the skin, the third measurement step (S312) may be performed.

The third measurement step (S312) includes a step of measuring the roughness of the epidermis phantom layer 750 and returning to the mixing step (S100) when the measured roughness is inconsistent with the roughness of the skin to be simulated. When the value measured during the third measurement step (S312) is consistent with the roughness of the skin, the fourth measurement step (S313) may be performed.

The fourth measurement step (S313) includes a step of measuring the thickness of the epidermis phantom layer 750 and returning to the mixing step (S100) when the measured thickness is inconsistent with the thickness of the skin to be simulated. When the value measured during the fourth measurement step (S313) is consistent with the thickness of the skin, the second lesion simulation step (S320) may be performed.

A pigment solution, which has a color that is different from that of the second colored solution, may be applied on the surface of the epidermis phantom layer 750 to embody the pigment lesion of the epidermis layer during the second lesion simulation step (S320). The pigment lesion is formed in the epidermis layer, which includes many pigments distributed therein, in the real skin.

As described above, in the present invention, the layers may be stacked using the 3D printer 600 to manufacture the skin-simulating phantom 700. Since the layers are stacked, various types of lesions may be embodied in the corium phantom layer 730 or the epidermis phantom layer 750. Driving of the nozzle tip 300 is controlled based on the setup, and accordingly, roughness may be imparted to the epidermis.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device for manufacturing a phantom simulating a skin using a 3D printer, the device comprising:
a pump unit storing colored solutions which are mixed depending on a property of a skin layer to be simulated;
a control unit controlling the 3D printer and the pump unit so that the colored solutions are sprayed to form at least one phantom layer; and
a nozzle tip connected to the 3D printer to extrude the colored solutions,
wherein the nozzle tip is controlled by the control unit to embody a rough epidermis of the formed phantom layer.

2. The device of claim 1, wherein the pump unit includes a temperature control motor controlling a temperature of the mixed colored solutions.

3. The device of claim 1, wherein the control unit includes an output control motor controlling a diameter of the nozzle tip, depending on concentrations of the colored solutions, to maintain an extrusion speed constant.

4. The device of claim 1, further comprising:
a light source curing the colored solutions sprayed from the nozzle tip.

5. The device of claim 4, wherein a curing agent is added to the colored solutions so as to induce curing by the light source.

6. The device of claim 1, further comprising:
a print stage on which the colored solutions sprayed from the nozzle tip are cured to form at least one phantom layer.

7. The device of claim 1, wherein an extrusion hole in the nozzle tip has a polygonal shape.

8. The device of claim 1, wherein the nozzle tip is vibrated up and down while horizontally moving to stack layers, which include the extruded colored solutions, in any one form of a sine wave, a square wave, and a triangle wave to thus provide roughness.

9. A system for manufacturing a phantom simulating a skin using a 3D printer, the system comprising:
a pump unit storing colored solutions which are mixed depending on a property of a skin layer to be simulated;
a control unit controlling the 3D printer and the pump unit so that the colored solutions are sprayed to form at least one phantom layer;
a nozzle tip connected to the 3D printer to extrude the colored solutions; and
an inspection device measuring any one of an optical property, roughness, and a thickness of the phantom layer, which is formed by curing the colored solutions sprayed from the nozzle tip.

10. The system of claim 9, wherein the inspection device is a spectrophotometer that includes an integrating sphere that scatters-reflects light, which is radiated on the phantom layer, with a uniform magnitude; and a photo-detector measuring the optical property of the phantom layer using the light which is scattered-reflected by the integrating sphere.

11. The system of claim 9, wherein the inspection device is a surface roughness meter measuring depths of cristae cutis and a distance between the cristae cutis in order to measure the roughness of the phantom layer.

12. The system of claim 9, wherein the inspection device is an optical coherence tomography (OCT) imager measuring the thickness of the phantom layer using an interference signal of radiated light.

13. A method of manufacturing a phantom simulating a skin using a 3D printer, the method comprising:
a mixing step of manufacturing one or more types of colored solutions having a property of a skin layer to be simulated;
a first output step of extruding a first colored solution, which is manufactured during the mixing step, to manufacture a corium phantom layer; and
a second output step of controlling a nozzle tip of the 3D printer while a second colored solution, which is manufactured during the mixing step, is extruded to thus manufacture a rough epidermis phantom layer.

14. The method of claim 13, wherein a light-scattering material is added to a medium solution including a plastic fluid to manufacture the first colored solution, which has a light-scattering property of the corium layer, during the mixing step.

15. The method of claim 13, wherein a light-absorbing material is added to a medium solution including a plastic fluid to manufacture the second colored solution, which has a light-absorbing property of the epidermis layer, during the mixing step.

16. The method of claim 13, wherein the first output step includes a first lesion simulation step of applying a pigment solution, which has a color that is different from the color of the first colored solution, on a surface of the corium phantom layer to embody a vascular lesion of the corium layer.

17. The method of claim 13, wherein the second output step includes a second lesion simulation step of applying a pigment solution, which has a color that is different from the color of the second colored solution, on a surface of the epidermis phantom layer to embody a pigment lesion of the epidermis layer.

18. The method of claim 13, wherein a curing agent is added to the colored solutions so as to induce curing by a light source during the mixing step.

19. The method of claim 13, wherein a third colored solution, which is added so as to provide a property of a subcutaneous fat layer during the mixing step, is cured in a mold to manufacture a subcutaneous fat phantom layer, and the first colored solution is extruded on the manufactured subcutaneous fat phantom layer to manufacture the corium phantom layer during the first output step.

20. The method of claim 13, wherein the first output step includes a first measurement step of measuring an optical property of the manufactured corium phantom layer and returning to the mixing step when the measured optical property is inconsistent with the optical property of the skin to be simulated.

21. The method of claim 13, wherein the second output step includes
a second measurement step of measuring an optical property of the manufactured epidermis phantom layer and returning to the mixing step when the measured optical property is inconsistent with the optical property of the skin to be simulated;
a third measurement step of measuring roughness of the epidermis phantom layer after the second measurement step and returning to the mixing step when the measured roughness is inconsistent with the roughness of the skin to be simulated; and
a fourth measurement step of measuring a thickness of the epidermis phantom layer after the third measurement step and returning to the mixing step when the measured thickness is inconsistent with the thickness of the skin to be simulated.

22. The method of claim 13, wherein the nozzle tip is vibrated up and down while horizontally moving to manufacture the rough epidermis phantom layer during the second output step.

23. The method of claim 22, wherein a driving speed of the nozzle tip is controlled to stack layers, which include extruded colored solutions, in any one form of a sine wave, a square wave, and a triangle wave to thus manufacture the rough epidermis phantom layer, during the second output step.
